(19) United States
(12) Patent Application Publication
(10) Pub. No.: US 2010/0004040 A1
(43) Pub. Date: Jan. 7, 2010

(54) METHOD OF CONDUCTING A CARD GAME

(76) Inventor: Brian Orjiako, Las Vegas, NV (US)

Correspondence Address: GREENBERG TRAURIG (LV), 3773 HOWARD HUGHES PARKWAY, Suite 400 North, LAS VEGAS, NV, 89169, US

(21) Appl. No.: 12/489,283

(22) Filed: Jun. 22, 2009

Related U.S. Application Data
(60) Provisional application No. 61/074,460, filed on Jun. 20, 2008.

(51) Int. Cl. A63F 9/24; A63F 13/00

(52) U.S. Cl. 463/3; 463/13; 463/40

(57) ABSTRACT

A method of conducting a video poker-style card game is disclosed. The method involves displaying three initial cards. Secondary cards are displayed at a home plate area, first base area, second base area and third base area of a displayed baseball diamond. Four poker hands are formed using the initial cards in combination with the secondary cards at a: 1) home plate area and first base area; 2) first base area and second base area; 3) second base area and third base are; and 4) third base area and home plate area. Payouts are made based on a strength of one or more of the four hands. Players may also be provided with a draw option and second wager feature.

### CROSS-REFERENCE TO RELATED APPLICATIONS

This application claims the benefit of U.S. Provisional Application No. 61/074,460 filed Jun. 20, 2008.

### FIELD OF THE INVENTION

The embodiments of the present invention relate to an electronic card game premised on the popular game of video poker. More particularly, the embodiments relate to a method of conducting a video poker-style game utilizing a partial starting hand in combination with multiple sets of secondary cards utilized to complete one or more final video poker hands.

### BACKGROUND

Video poker is the most popular non-slot video game in the casinos. Conventional video poker consists of a player placing a wager of one to five coins or units. The player is then shown five cards, from a simulated deck of 52 cards, on a video poker display. The player may then elect which cards to hold and discard. All discards are then replaced with new cards from the deck. The player receives a payout, if any, based on the strength of the poker hand after the draw. There are many different payout schemes available. In addition, numerous video poker variations, including Triple Play Poker®, have been placed in the marketplace

While there are many video poker games available in the casino marketplace, there is always a need for additional video poker games which can attract new players and maintain existing players.

### SUMMARY

Accordingly, the embodiments of the present invention relate to a video poker-style game wherein a player receives a partial poker hand which is combined with secondary cards to form one or more poker hands. In one embodiment, the player against a pay table which list payouts relative to certain pre-established final poker hands. In one embodiment, the game layout is based on a baseball diamond wherein said secondary cards are positioned at home, first base, second base and third base. In this embodiment, the player receives three cards and uses the cards at home and first base; first base and second base, second base and third base; and third base and home to create four five-card poker hands from which one or more payouts are made. In one embodiment, players are able to replace one or more cards via a conventional draw procedure.

Various betting options and payout structures, as described below, are available with the embodiments of the present invention. Multiple different procedures and rules are also available described below. The embodiments of the present invention are ideal for electronic play, but may also be played in a live environment at a gaming table.

Other variations, embodiments and features of the present invention will become evident from the following detailed description, drawings and claims.

### BRIEF DESCRIPTION OF THE DRAWINGS

FIGS. 1a-1c illustrate exemplary screen shots according to one embodiment of the present invention;

FIGS. 2a-2d illustrate exemplary screen shots according to another embodiment of the present invention;

FIG. 3 shows a flow chart detailing a method of play according to one embodiment of the present invention; and

FIG. 4 shows a flow chart detailing a method of play according to another embodiment of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

The embodiments of the present invention are premised on the game of video poker. Video poker is a game facilitated by a an electronic gaming device. Players first place wagers on a poker hand outcome. Then, the player is shown five random cards which the player retains or discards as desired. Each discard is replaced with a new card. The final poker hand is then evaluated and based on the rank of the poker hand a payout is made. In most instances, in order to receive a payout the final poker hand must have a rank of pair of Jacks or better. There are numerous different pay tables associated with video poker games currently in the market (e.g., 7/5, 6/5, double bonus poker, double double bonus poker, etc.). The embodiments of the present invention differ significantly from basic video poker and provide more excitement than basic video poker.

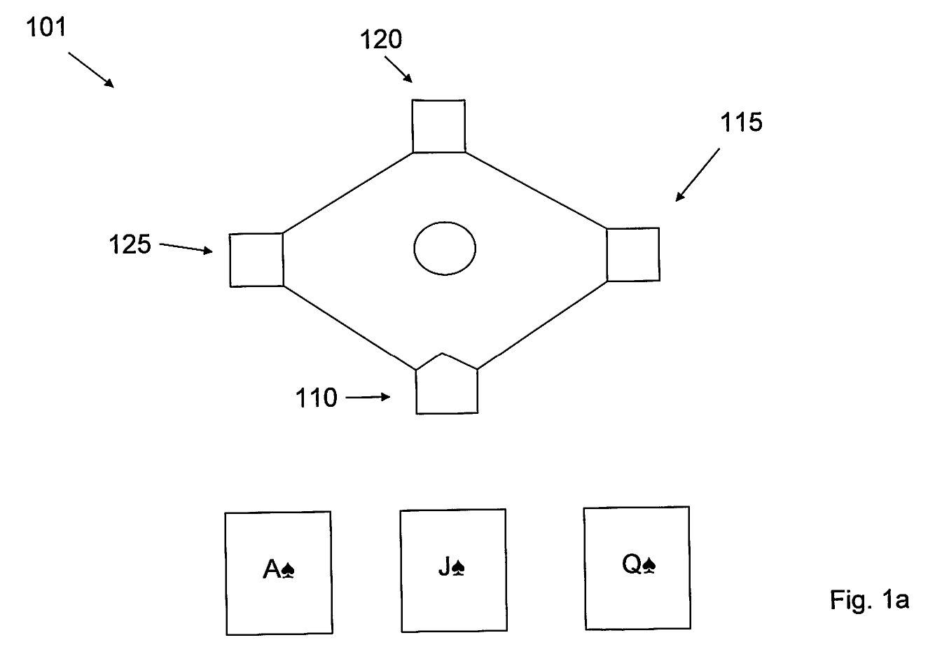

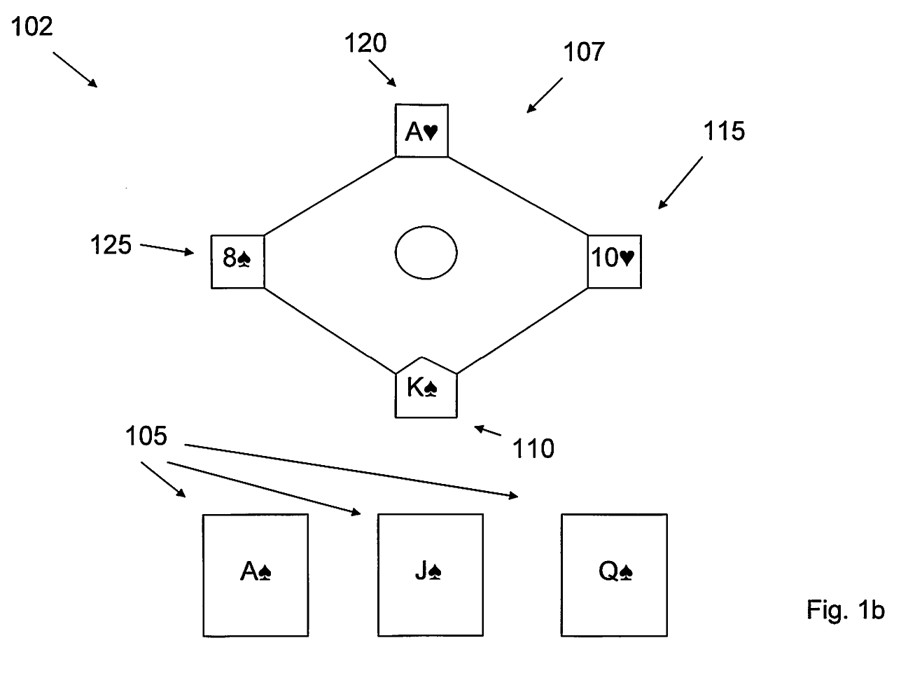

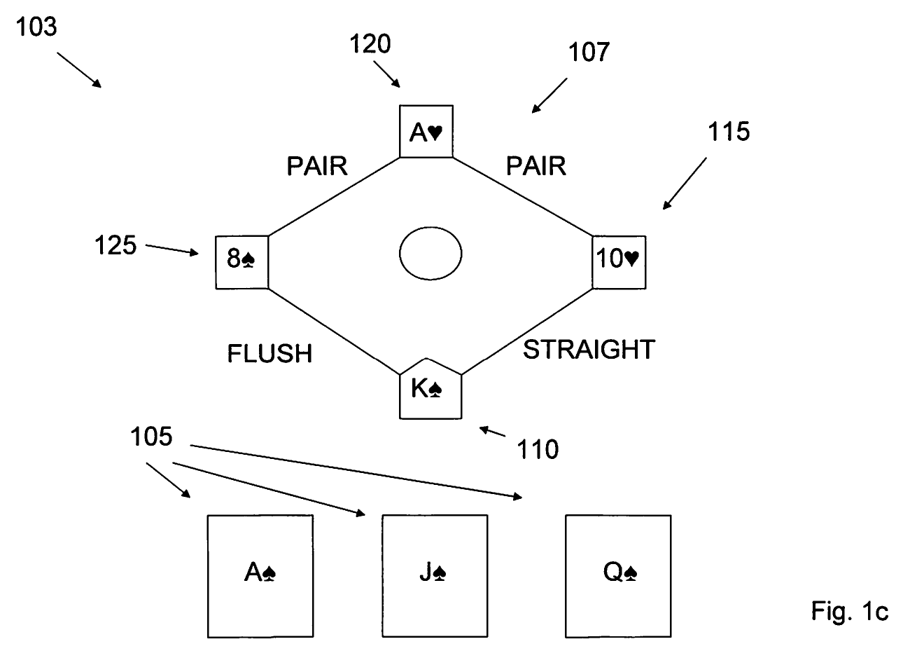

FIGS. 1a-1c show exemplary screen shots of a first embodiment of the present invention. As shown, the embodiments of the present invention are facilitated by an electronic gaming device having a display, player interface (e.g., buttons or touch screen), random number generator, and processor. The same type of electronic gaming device may be used to facilitate the embodiments of the present invention albeit with different processor programming.

Screen shot 101 of FIG. 1a shows three initial cards after the player has placed a wager. In other embodiments of the player may receive more or less than three initial cards. The three cards 105 comprise the A [symbol] , J [symbol] and Q [symbol] . A baseball diamond 107 depicts a home plate 110, first base 115, second base 120 and third base 125. Next, as shown in screen shot 102 of FIG. 1b, four cards, one at each of home plate 110, first base 115, second base 120 and third base 125, are displayed. As shown, the K [symbol] is displayed at home plate 110; the 10♡ is displayed at first base 115; the A♡ is displayed at second base 120; and the 8 [symbol] is displayed at third base 125. In one embodiment of the present invention, after the initial three cards are displayed, the player may be permitted to place a second wager prior to receiving the four cards at home plate 110, first base 115, second base 120 and third base 125. In one embodiment, the second wager must be double the first wager. In other embodiments, the second wager may take different forms. Now referring to screen shot 103 of FIG. 1c, the base paths of the diamond 105 display the final hands of the round of play. The base path from home plate 110 to first base 115 displays “STRAIGHT” formed by combining the three players cards (A [symbol] , J [symbol] and Q [symbol] ) with the K [symbol] displayed at home plate 110 and the 10♡ displayed at first base 115. The base path from first base 115 to second base 120 displays “PAIR” (i.e., two Aces) formed by combining the three players cards (A [symbol] , J [symbol] and Q [symbol] ) with the 10♡ displayed at first base 115 and the A♡ displayed at second base 120. The base path from second base to the third base displays “PAIR” (i.e., two Aces) formed by combining the three players cards (A [symbol] , J [symbol] and Q [symbol] ) with the A♡ displayed at second base 120 and the 8 [symbol] displayed at third base 125. The base path from third base 125 to home plate 110 displays “FLUSH” formed by combining the three players cards (A [symbol] , J [symbol] and Q [symbol] ) with the 8 [symbol] is displayed at third base 125 and the K [symbol] displayed at home plate 110.

In one embodiment, only the highest ranking poker hand is subject to a payout. Therefore, only the FLUSH identified in FIG. 1c receives a payout. In other embodiments, all winning hands (i.e., hands matching or exceeding a pre-established minimum hand ranking are subject to a payout. In this embodiment, different wager amounts may be necessary and the player may elect in advance to play only certain base paths. Again, referring to FIG. 1c, assuming the minimum ranking poker hand is a pair of Jacks, all four hands would be subject to a payout. Payouts may vary greatly and depend on the desired house advantage associated with the underlying game. Table 1 below consists of an exemplary payout structure based on a minimum hand rank of a pair of Jacks or better.

TABLE 1

| Poker Hand | Payout |
|---|---|
| Royal Flush | 100 to 1 |
| Straight Flush (10 high-King high) | 50 to 1 |
| Straight Flush (5 high-9 high) | 25 to 1 |
| Four of a Kind (Jacks-Aces) | 50 to 1 |
| Four of a Kind (2-10) | 25 to 1 |
| Full House | 8 to 1 |
| Flush | 4 to 1 |
| Straight | 3 to 1 |
| Trips | 2 to 1 |
| Two Pair | 1 to 1 |
| Jacks or Better | 1 to 1 |

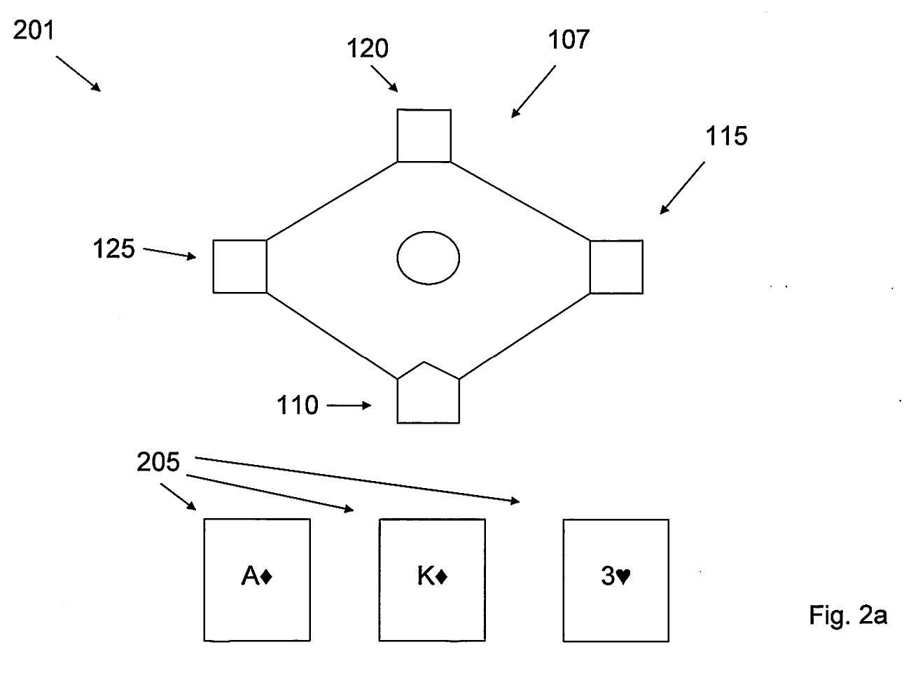

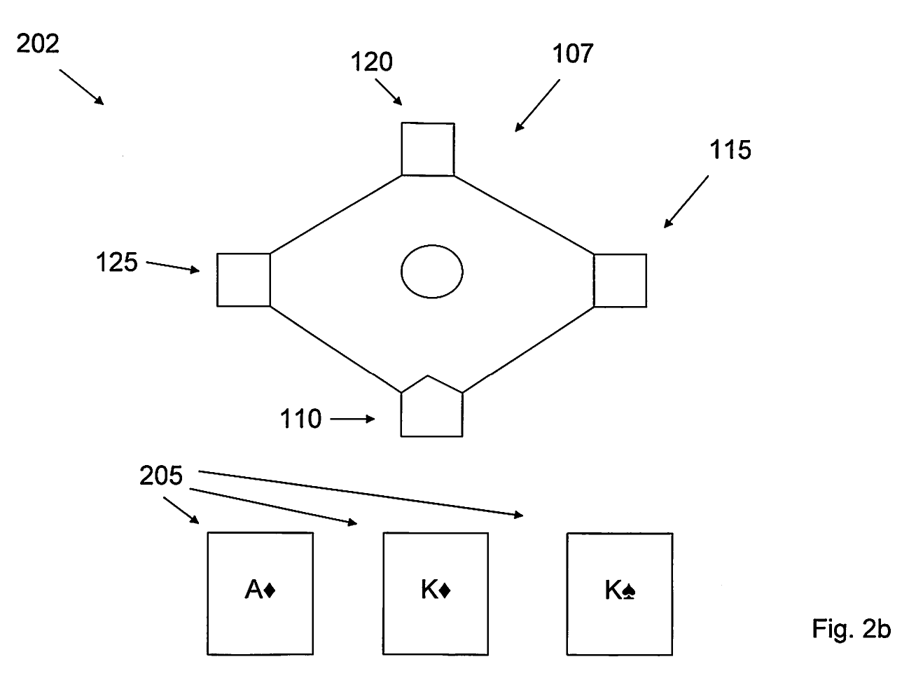

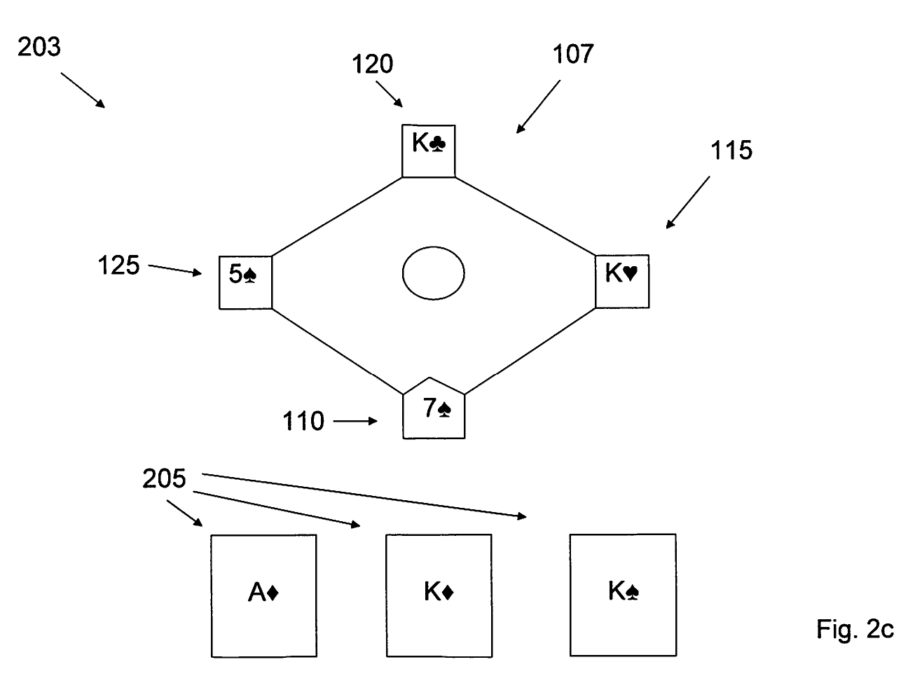

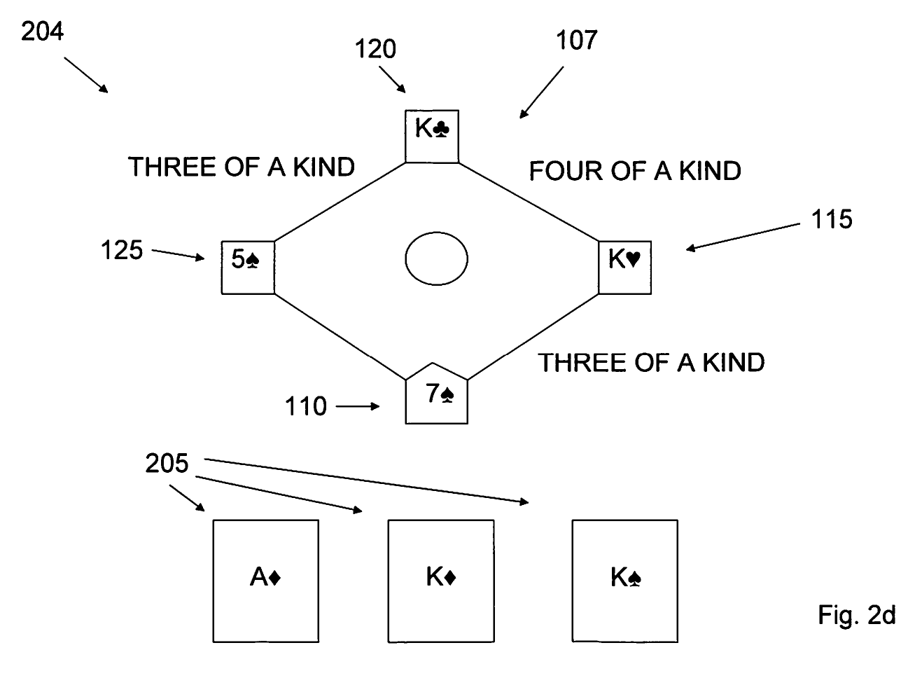

FIGS. 2a-2d show another embodiment of the present invention including the option for a player to replace one or more cards. Screen shot 201 of FIG. 2a shows three initial player cards 205 comprising the A♦, K♦ and 3♡. In this instance, the player is given one opportunity to replace one, two or all three cards. Alternatively, the player may be given one opportunity to replace only one card or two cards. The player may also be given more than one opportunity to replace cards. The draws may be free of charge or may require the player to pay a fee. In one embodiment, if the player elects to use the initial three cards without any draw, the player is given the opportunity to place a second wager in an amount double the initial wager (deemed a Home Run Double-Up). The second wager may also be more or less than double the initial wager. As shown in screen shot 202 of FIG. 2b, the player has elected to discard the 3♡ which has been replaced with the K [symbol] . Therefore, the player now holds a beginning hand of A♦, K♦ and K [symbol] . As shown on screen shot 203 of FIG. 2c, the 7 [symbol] is displayed at home plate 110; the K♡ is displayed at first base 115; the K [symbol] is displayed at second base 120; and the 5 [symbol] is displayed at third base 125. Screen shot 204 of FIG. 2d shows the base path from home plate 110 to first base 115 displaying “THREE OF A KIND” (i.e., three Kings) formed by combining the three players cards (A♦, K♦ and K [symbol] ) with the 7 [symbol] displayed at home plate 110 and the K♡ displayed at first base 115. The base path from first base 115 to second base 120 displays “FOUR OF A KIND” (i.e., four Kings) formed by combining the three players cards (A♦, K♦ and K [symbol] ) with the K♡ displayed at first base 115 and the K [symbol] displayed at second base 120. The base path from second base to the third base displays “THREE OF A KIND” (i.e., three Kings) formed by combining the three players cards (A♦, K♦ and K [symbol] ) with the K [symbol] displayed at second base 120 and the 5 [symbol] displayed at third base 125. The base path from third base 125 to home plate 110 displays nothing indicative of no winning hand.

The pay table shown in Table 1 may be used with the draw embodiment or may be modified based on the inclusion of the draw. In one embodiment, the pay table may include payouts for certain starting hands which do not result in a winning outcome. For example, if the player starts with a open ended Royal Flush and Straight Flush draws the player may win a payout just for starting with the high risk starting hand.

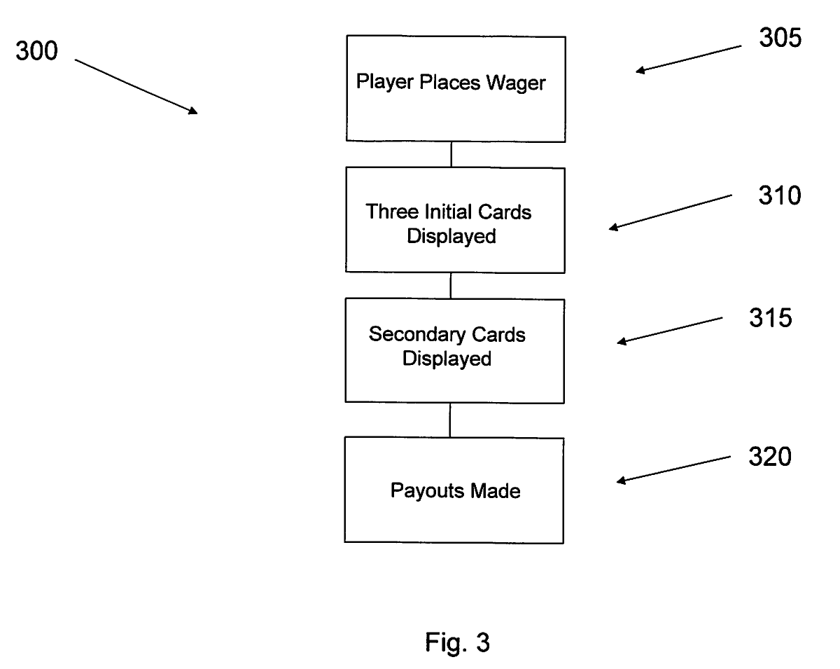

FIG. 3 shows a flow chart 300 detailing one method of conducting a card game according to one embodiment of the present invention. At 305, a player places a wager. The potential range of wagers accepted by the electronic gaming device is dictated by the casino offering the game of chance. At 310, three initial cards are displayed on a display of the electronic gaming device. At 315, four secondary cards, one at home plate, first base, second base and third base are displayed. At 320, a payout is calculated based on the highest ranking hand or all winning hands depending on the embodiment.

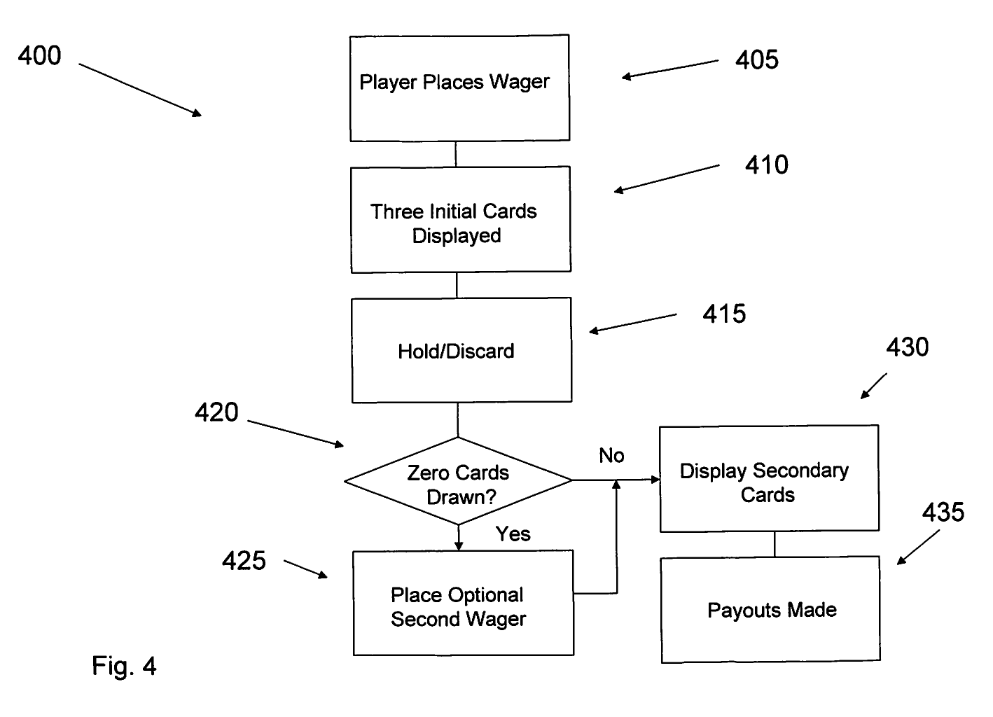

FIG. 4 shows a flow chart 400 detailing one method of conducting a card game according to one embodiment of the present invention. At 405, a player places a wager. The potential range of wagers accepted by the electronic gaming device is dictated by the casino offering the game of chance. At 410, three initial cards are displayed on a display of the electronic gaming device. At 415, the player decides which initial cards to hold and discard. There may be more than one such draw step in other embodiments. At 420, it is determined whether the player has held all initial cards. If so, at 425, the player may place an optional second wager. If not, at 430, four secondary cards, one at home plate, first base, second base and third base are displayed. The secondary cards are also displayed after the second wager is made. At 435, a payout is calculated based on the highest ranking hand or all winning hands depending on the embodiment.

It should be understood that the games described herein may have various other wagering, game play, or bonusing features which are within the scope of the invention.

It should be understood that a game according to the embodiments of the present invention may be incorporated in a standalone, single player video poker or electronic gaming machine platform, as a live table game with a dealer or in a fully or partially automated or interactive, computerized platform supporting multiple player positions. It should be readily apparent that additional computerized or manual systems may be employed in accordance with the embodiments of the present invention in order to achieve its full implementation.

Those skilled in the art will readily appreciate that the games and methods described above may be incorporated in various systems in accordance with the embodiments of the present invention.

For example, systems of the embodiments of the present invention may include various computer and network related software and hardware, such as programs, operating systems, memory storage devices, input/output devices, processors, servers with links to data communication systems, wireless or otherwise, and data transceiving terminals. Those skilled in the art will further appreciate that the precise types of software and hardware used are not vital to the full implementation of the embodiments of the present invention so long as players and operators are provided with useful access thereto.

While exemplary methods and applications of the methods of the present disclosure, have been described herein, it should also be understood that the foregoing is only illustrative of exemplary and/or preferred embodiments, as well as principles of the present invention, and that various modifications can be made by those skilled in the art without departing from the scope and spirit of the invention.

Therefore, the described embodiments should not be considered as limiting of the present invention in any way. Accordingly, the present invention embraces alternatives, modifications and variations which fall within the spirit and scope of the present invention as described herein.

I claim:

1. A method of conducting a card game comprising:
providing an electronic gaming device configured to:
accept an initial player wager;
display a baseball diamond including at least a home plate area, first base area, second base area and third base area;
display one or more initial cards;
display a secondary card at each of said home plate area, first base area, second base area and third base area;
evaluate a combination of said one or more initial cards with the secondary cards forming four poker hands comprising:
a) the one or more initial cards, the secondary card at said home plate area and the secondary card at said first base area;
b) the one or more initial cards, the secondary card at said first base area and the secondary card at said second base area;
c) the one or more initial cards, the secondary card at said second base area and the secondary card at said third base area; and
d) the one or more initial cards, the secondary card at said first base area and the secondary card at said second base area; and
provide a payout, if any, based on a strength of one or more of said four poker hands.

2. The method of claim 1 further comprising allowing players to place one or more wagers after receiving the one or more initial cards.

3. The method of claim 1 further comprising displaying three initial cards.

4. The method of claim 1 further comprising providing a payout for only the highest ranking poker hand of said four poker hands matching or exceeding a pre-established minimum ranking poker hand.

5. The method of claim 1 further comprising providing a payout for each of said four poker hands matching or exceeding a pre-established minimum ranking poker hand.

6. The method of claim 1 further comprising displaying final poker hand strengths of said four poker hands along base paths of the baseball diamond.

7. A method of conducting a card game comprising:
providing an electronic gaming device configured to:
accept an initial player wager;
display a baseball diamond including at least a home plate area, first base area, second base area and third base area;
display one or more initial cards;
allow a player one or more opportunities to retain and discard certain of said one or more initial cards wherein discards are replaced with new cards;
display a secondary card at each of said home plate area, first base area, second base area and third base area;
evaluate a combination of said one or more initial cards with the secondary cards to form four poker hands comprising:
a) the one or more initial cards, the secondary card at said home plate area and the secondary card at said first base area;
b) the one or more initial cards, the secondary card at said first base area and the secondary card at said second base area;
c) the one or more initial cards, the secondary card at said second base area and the secondary card at said third base area; and
d) the one or more initial cards, the secondary card at said first base area and the secondary card at said second base area; and
provide a payout, if any, based on a strength of one or more of said four poker hands. said one or more initial cards with the secondary cards to forming four poker hands comprising:
a) the one or more initial cards, the secondary card at said home plate area and the secondary card at said first base area;
b) the one or more initial cards, the secondary card at said first base area and the secondary card at said second base area;
c) the one or more initial cards, the secondary card at said second base area and the secondary card at said third base area; and
d) the one or more initial cards, the secondary card at said first base area and the secondary card at said second base area; and
provide a payout, if any, based on a strength of one or more of said four poker hands.

8. The method of claim 7 further comprising allowing players to place one or more additional wagers after receiving the one or more initial cards.

9. The method of claim 7 further comprising displaying three initial cards.

10. The method of claim 7 further comprising providing a payout for only the highest ranking poker hand of said four poker hands matching or exceeding a pre-established minimum ranking poker hand.

11. The method of claim 7 further comprising providing a payout for each of said four poker hands matching or exceeding a pre-established minimum ranking poker hand.

12. The method of claim 7 further comprising displaying final poker hand strengths of said four poker hands along base paths of the baseball diamond.

13. An electronic gaming device comprising:
bill and ticket collector;
player interface;
display; and
a processor programmed to:
display a baseball diamond including at least a home plate area, first base area, second base area and third base area;
display one or more initial cards;
display a secondary card at each of said home plate area, first base area, second base area and third base area;
evaluate a combination of said one or more initial cards with the secondary cards forming four poker hands comprising:
a) the one or more initial cards, the secondary card at said home plate area and the secondary card at said first base area;
b) the one or more initial cards, the secondary card at said first base area and the secondary card at said second base area;
c) the one or more initial cards, the secondary card at said second base area and the secondary card at said third base area; and
d) the one or more initial cards, the secondary card at said first base area and the secondary card at said second base area; and
provide a payout, if any, based on a strength of one or more of said four poker hands.

14. The device of claim 13 wherein said processor is further programmed to allow players to place one or more wagers after receiving the one or more initial cards.

15. The device of claim 13 wherein said processor is further programmed to display three initial cards.

16. The device of claim 13 wherein said processor is further programmed to provide a payout for only the highest ranking poker hand of said four poker hands matching or exceeding a pre-established minimum ranking poker hand.

17. The device of claim 13 wherein said processor is further programmed to provide a payout for each of said four poker hands matching or exceeding a pre-established minimum ranking poker hand.

18. The device of claim 13 wherein the processor is further programmed to allow a player one or more opportunities to retain and discard certain of said one or more initial cards wherein discards are replaced with new cards.

19. The device of claim 13 wherein said processor is further programmed to display final poker hand strengths of said four poker hands along base paths of the baseball diamond.
